(19) United States
(12) Patent Application Publication
(10) Pub. No.: US 2008/0133702 A1
(43) Pub. Date: Jun. 5, 2008

(54) DATA CONVERSION SERVER FOR VOICE BROWSING SYSTEM

(76) Inventors: Dipanshu Sharma, San Diego, CA (US); Sunil Kumar, San Diego, CA (US); Chandra Kholia, San Diego, CA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 11/952,064

(22) Filed: Dec. 6, 2007

Related U.S. Application Data
(63) Continuation of application No. 10/336,218, filed on Jan. 3, 2003, now abandoned.
(60) Provisional application No. 60/348,579, filed on Jan. 14, 2002.

(51) Int. Cl. G06F 15/16

(52) U.S. Cl. 709/217

(57) ABSTRACT

A conversion server responsive to browsing requests issued by a browser unit operative in accordance with a first protocol is disclosed herein. The conversion server includes a retrieval module for retrieving web page information from a web site in accordance with a first browsing request issued by the browsing unit. The retrieved web page information is formatted in accordance with a second protocol different from the first protocol. A conversion module serves to convert at least a primary portion of the web page information into a primary file of converted information compliant with the first protocol. The conversion server also includes an interface module for providing said primary file of converted information to the browsing unit.

### CROSS-REFERENCE TO RELATED APPLICATIONS

This application is a continuation of and claims priority to co-pending U.S. Utility patent application Ser. No. 10/336,218, entitled DATA CONVERSION SERVER FOR VOICE BROWSING SYSTEM, filed Jan. 3, 2003, which claims priority to U.S. Provisional Patent Application Ser. No. 60/348,579, entitled DATA CONVERSION SERVER FOR VOICE BROWSING SYSTEM, filed Jan. 14, 2002. This application is also related to U.S. Utility patent application Ser. No. 10/040,525, entitled INFORMATION RETRIEVAL SYSTEM INCLUDING VOICE BROWSER AND DATA CONVERSION SERVER, filed Dec. 28, 2001. Each of these applications is hereby incorporated by reference herein in their entirety for all purposes.

### FIELD OF THE INVENTION

The present invention relates to the field of browsers used for accessing data in a distributed computing environment, and, in particular, to methods and systems for accessing such data in an Internet environment using Web browsers controlled at least in part through voice commands.

### BACKGROUND OF THE INVENTION

As is well known, the World Wide Web, or simply “the Web”, is comprised of a large and continuously growing number of accessible Web pages. In the Web environment, clients request Web pages from Web servers using the Hypertext Transfer Protocol (“HTTP”). HTTP is a protocol which provides users access to files including text, graphics, images, and sound using a standard page description language known as the Hypertext Markup Language (“HTML”). HTML provides document formatting allowing the developer to specify links to other servers in the network. A Uniform Resource Locator (URL) defines the path to Web site hosted by a particular Web server.

The pages of Web sites are typically accessed using an HTML-compatible browser (e.g., Netscape Navigator or Internet Explorer) executing on a client machine. The browser specifies a link to a Web server and particular Web page using a URL. When the user of the browser specifies a link via a URL, the client issues a request to a naming service to map a hostname in the URL to a particular network IP address at which the server is located. The naming service returns a list of one or more IP addresses that can respond to the request. Using one of the IP addresses, the browser establishes a connection to a Web server. If the Web server is available, it returns a document or other object formatted according to HTML.

As Web browsers become the primary interface for access to many network and server services, Web applications in the future will need to interact with many different types of client machines including, for example, conventional personal computers and recently developed “thin” clients. Thin clients can range between 60 inch TV screens to handheld mobile devices. This large range of devices creates a need to customize the display of Web page information based upon the characteristics of the graphical user interface (“GUI”) of the client device requesting such information. Using conventional technology would most likely require that different HTML pages or scripts be written in order to handle the GUI and navigation requirements of each client environment.

Client devices differ in their display capabilities, e.g., monochrome, color, different color palettes, resolution, sizes. Such devices also vary with regard to the peripheral devices that may be used to provide input signals or commands (e.g., mouse and keyboard, touch sensor, remote control for a TV set-top box). Furthermore, the browsers executing on such client devices can vary in the languages supported, (e.g., HTML, dynamic HTML, XML, Java, JavaScript). Because of these differences, the experience of browsing the same Web page may differ dramatically depending on the type of client device employed.

The inability to adjust the display of Web pages based upon a client's capabilities and environment causes a number of problems. For example, a Web site may simply be incapable of servicing a particular set of clients, or may make the Web browsing experience confusing or unsatisfactory in some way. Even if the developers of a Web site have made an effort to accommodate a range of client devices, the code for the Web site may need to be duplicated for each client environment. Duplicated code consequently increases the maintenance cost for the Web site. In addition, different URLs are frequently required to be known in order to access the Web pages formatted for specific types of client devices.

In addition to being satisfactorily viewable by only certain types of client devices, content from Web pages has been generally been inaccessible to those users not having a personal computer or other hardware device similarly capable of displaying Web content. Even if a user possesses such a personal computer or other device, the user needs to have access to a connection to the Internet. In addition, those users having poor vision or reading skills are likely to experience difficulties in reading text-based Web pages. For these reasons, efforts have been made to develop Web browsers for facilitating non-visual access to Web pages for users that wish to access Web-based information or services through a telephone. Such non-visual Web browsers, or “voice browsers”, present audio output to a user by converting the text of Web pages to speech and by playing pre-recorded Web audio files from the Web. A voice browser also permits a user to navigate between Web pages by following hypertext links, as well as to choose from a number of pre-defined links, or “bookmarks” to selected Web pages. In addition, certain voice browsers permit users to pause and resume the audio output by the browser.

A particular protocol applicable to voice browsers appears to be gaining acceptance as an industry standard. Specifically, the Voice eXtensible Markup Language (“VoiceXML”) is a markup language developed specifically for voice applications useable over the Web, and is described at http://www.voicexml.org. VoiceXML defines an audio interface through which users may interact with Web content, similar to the manner in which the Hypertext Markup Language (“HTML”) specifies the visual presentation of such content. In this regard VoiceXML includes intrinsic constructs for tasks such as dialogue flow, grammars, call transfers, and embedding audio files.

Unfortunately, the VoiceXML standard generally contemplates that VoiceXML-compliant voice browsers interact exclusively with Web content of the VoiceXML format. This has limited the utility of existing VoiceXML-compliant voice browsers, since a relatively small percentage of Web sites include content formatted in accordance with VoiceXML. In addition to the large number of HTML-based Web sites, Web sites serving content conforming to standards applicable to particular types of user devices are becoming increasingly prevalent. For example, the Wireless Markup Language (“WML”) of the Wireless Application Protocol (“WAP”) (see, e.g., http://www.wapforum.org/) provides a standard for developing content applicable to wireless devices such as mobile telephones, pagers, and personal digital assistants. Some lesser-known standards for Web content include HDML, and the relatively new Japanese standard Compact HTML.

The existence of myriad formats for Web content complicates efforts by corporations and other organizations make Web content accessible to substantially all Web users. That is, the ever increasing number of formats for Web content has rendered it time consuming and expensive to provide Web content in each such format. Accordingly, it would be desirable to provide a technique for enabling existing Web content to be accessed by standardized voice browsers, irrespective of the format of such content.

### SUMMARY OF THE INVENTION

In summary, the present invention is directed to a conversion server responsive to browsing requests issued by a browser unit operative in accordance with a first protocol. The conversion server includes a retrieval module for retrieving web page information from a web site in accordance with a first browsing request issued by the browsing unit. The retrieved web page information is formatted in accordance with a second protocol different from the first protocol. A conversion module serves to convert at least a primary portion of the web page information into a primary file of converted information compliant with the first protocol. The conversion server also includes an interface module for providing said primary file of converted information to the browsing unit.

The present invention also relates to a method for facilitating browsing of the Internet. The method includes receiving a browsing request from a browser unit operative in accordance with a first protocol, wherein the browsing request is issued by the browser unit in response to a first user request for web content. Web page information, formatted in accordance with a second protocol different from the first protocol, is retrieved from a web site in accordance with the browsing request. The method further includes converting at least a primary portion of the web page information into a primary file of converted information compliant with the first protocol.

### BRIEF DESCRIPTION OF THE DRAWINGS

For a better understanding of the nature of the features of the invention, reference should be made to the following detailed description taken in conjunction with the accompanying drawings, in which:

FIG. 1 provides a schematic diagram of a voice-based system for accessing Web content which incorporates a conversion server of the present invention.

FIG. 2 shows a block diagram of a voice browser included within the system of FIG. 1.

FIG. 3 depicts a functional block diagram of the conversion server of the present invention.

FIG. 4 is a flow chart representative of operation of the conversion server in accordance with the present invention.

FIGS. 5A and 5B are collectively a flowchart illustrating an exemplary process for transcoding a parse tree representation of an WML-based document into an output document comporting with the VoiceXML protocol.

### DETAILED DESCRIPTION OF THE INVENTION

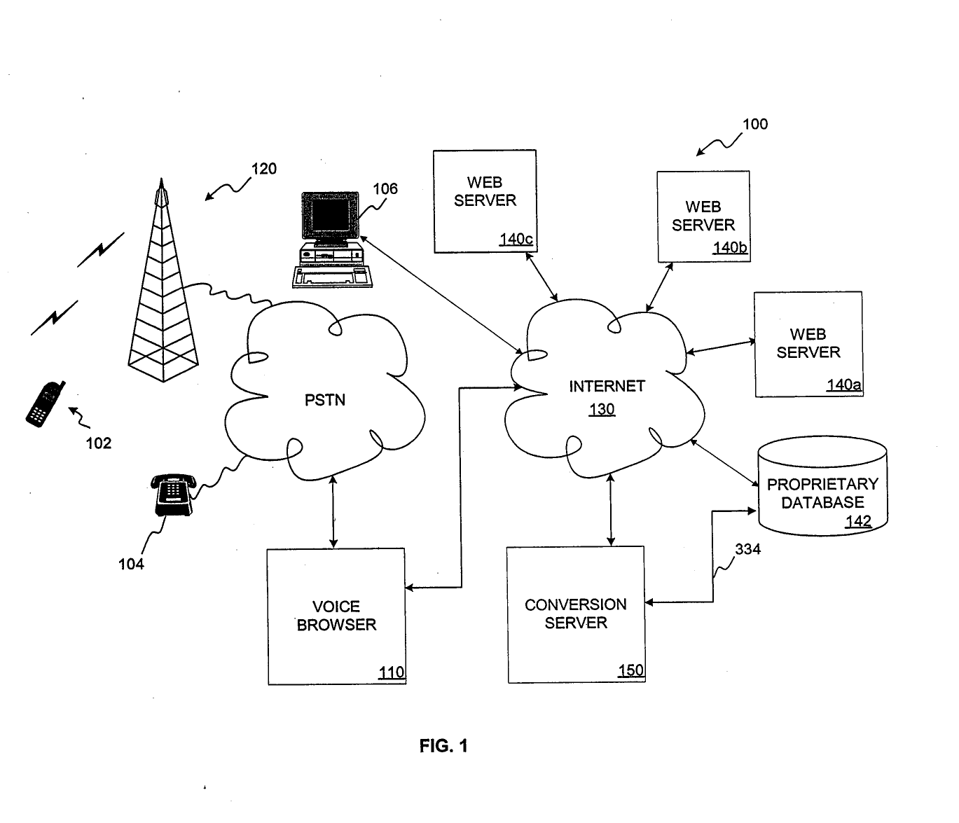

FIG. 1 provides a schematic diagram of a voice-based system 100 for accessing Web content which incorporates a conversion server 150 of the present invention. The system 100 includes a telephonic subscriber unit 102 in communication with a voice browser 110 through a telecommunications network 120. In a preferred embodiment the voice browser 110 executes dialogues with a user of the subscriber unit 102 on the basis of document files comporting with a known speech mark-up language (e.g., VoiceXML). The voice browser 110 generally obtains such document files in at least two different ways in response to requests for Web content submitted through the subscriber unit 102. If the request for content is from a Web site operative in accordance with the protocol applicable to the voice browser 110 (e.g., VoiceXML), then the voice browser 110 obtains the requested Web content via the Internet 130 directly from a Web server 140 hosting the Web site of interest. However, when it is desired to obtain content from a Web site formatted inconsistently with the voice browser 110, the voice browser 110 forwards a request for Web content to the inventive conversion server 150. In accordance with the present invention, the conversion server 150 retrieves content from the Web server 140 hosting the Web site of interest and converts this content into a document file compliant with the protocol of the voice browser 110. The converted document file is then provided by the conversion server 150 to the voice browser 110, which then uses this file to effect a dialogue conforming to the applicable voice-based protocol with the user of subscriber unit 102.

As is described below, the conversion server 150 of the present invention operates to convert or transcode conventional structured document formats (e.g., HTML) into the format applicable to the voice browser 110 (e.g., VoiceXML). This conversion is generally effected by performing a predefined mapping of the syntactical elements of conventional structured documents harvested from Web servers 140 into corresponding equivalent elements contained within an XML-based file formatted in accordance with the protocol of the voice browser 110. The resultant XML-based file may include all or part of the “target” structured document harvested from the applicable Web server 140, and may also include optionally include additional content provided by the conversion server 150. In the exemplary embodiment the target document is parsed, and identified tags, styles and content can either be replaced or removed.

Referring again to FIG. 1, the subscriber unit 102 is in communication with the voice browser 110 via the telecommunications network 120. The subscriber unit 102 has a keypad (not shown) and associated circuitry for generating Dual Tone MultiFrequency (DTMF) tones. The subscriber unit 102 transmits DTMF tones to, and receives audio output from, the voice browser 110 via the telecommunications network 120. In FIG. 1, the subscriber unit 102 is exemplified with a mobile station and the telecommunications network 120 is represented as including a mobile communications network and the Public Switched Telephone Network (“PSTN”). However, the present invention is not intended to be limited to the exemplary representation of the system 100 depicted in FIG. 1. That is, the voice browser 110 can be accessed through any conventional telephone system from, for example, a stand-alone analog telephone, a digital telephone, or a node on a PBX.

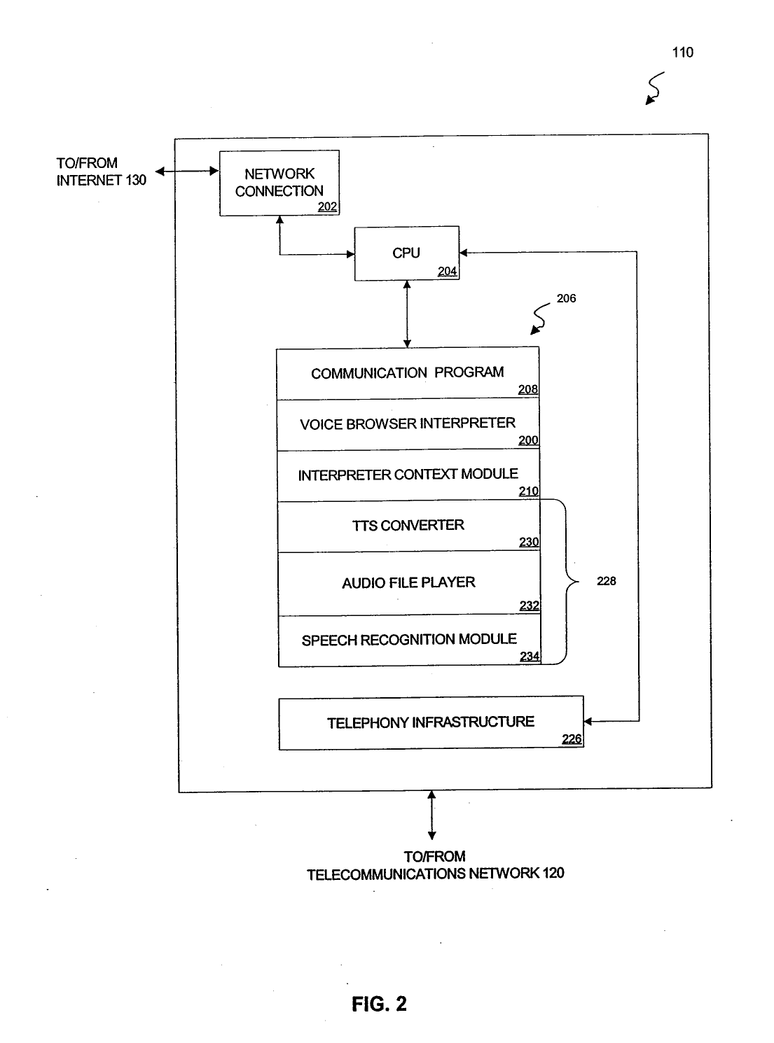

FIG. 2 shows a block diagram of the voice browser 110. The voice browser 110 includes certain standard server computer components, including a network connection device 202, a CPU 204 and memory (primary and/or secondary) 206. The voice browser 110 also includes telephony infrastructure 226 for effecting communication with telephony-based subscriber units (e.g., the mobile subscriber unit 102 and landline telephone 104). As is described below, the memory 206 stores a set of computer programs to implement the processing effected by the voice browser 110. One such program stored by memory 206 comprises a standard communication program 208 for conducting standard network communications via the Internet 130 with the conversion server 150 and any subscriber units operating in a voice over IP mode (e.g., personal computer 106).

As shown, the memory 206 also stores a voice browser interpreter 200 and an interpreter context module 210. In response to requests from, for example, subscriber unit 102 for Web or proprietary database content formatted inconsistently with the protocol of the voice browser 110, the voice browser interpreter 200 initiates establishment of a communication channel via the Internet 130 with the conversion server 150. The voice browser 110 then issues, over this communication channel and in accordance with conventional Internet protocols (i.e., HTTP and TCP/IP), browsing requests to the conversion server 150 corresponding to the requests for content submitted by the requesting subscriber unit. The conversion server 150 retrieves the requested Web or proprietary database content in response to such browsing requests and converts the retrieved content into document files in a format (e.g., VoiceXML) comporting with the protocol of the voice browser 110. The converted document files are then provided to the voice browser 110 over the established Internet communication channel and utilized by the voice browser interpreter 200 in carrying out a dialogue with a user of the requesting unit. During the course of this dialogue the interpreter context module 210 uses conventional techniques to identify requests for help and the like which may be made by the user of the requesting subscriber unit. For example, the interpreter context module 210 may be disposed to identify predefined “escape” phrases submitted by the user in order to access menus relating to, for example, help functions or various user preferences (e.g., volume, text-to-speech characteristics).

Referring to FIG. 2, audio content is transmitted and received by telephony infrastructure 226 under the direction of a set of audio processing modules 228. Included among the audio processing modules 228 are a text-to-speech (“TTS”) converter 230, an audio file player 232, and a speech recognition module 234. In operation, the telephony infrastructure 226 is responsible for detecting an incoming call from a telephony-based subscriber unit and for answering the call (e.g., by playing a predefined greeting). After a call from a telephony-based subscriber unit has been answered, the voice browser interpreter 200 assumes control of the dialogue with the telephony-based subscriber unit via the audio processing modules 228. In particular, audio requests from telephony-based subscriber units are parsed by the speech recognition module 234 and passed to the voice browser interpreter 200. Similarly, the voice browser interpreter 200 communicates information to telephony-based subscriber units through the text-to-speech converter 230. The telephony infrastructure 226 also receives audio signals from telephony-based subscriber units via the telecommunications network 120 in the form of DTMF signals. The telephony infrastructure 226 is able to detect and interpret the DTMF tones sent from telephony-based subscriber units. Interpreted DTMF tones are then transferred from the telephony infrastructure to the voice browser interpreter 200.

After the voice browser interpreter 200 has retrieved a VoiceXML document from the conversion server 150 in response to a request from a subscriber unit, the retrieved VoiceXML document forms the basis for the dialogue between the voice browser 110 and the requesting subscriber unit. In particular, text and audio file elements stored within the retrieved VoiceXML document are converted into audio streams in text-to-speech converter 230 and audio file player 232, respectively. When the request for content associated with these audio streams originated with a telephony-based subscriber unit, the streams are transferred to the telephony infrastructure 226 for adaptation and transmission via the telecommunications network 120 to such subscriber unit. In the case of requests for content from Internet-based subscriber units (e.g., the personal computer 106), the streams are adapted and transmitted by the network connection device 202.

The voice browser interpreter 200 interprets each retrieved VoiceXML document in a manner analogous to the manner in which a standard Web browser interprets a visual markup language, such as HTML or WML. The voice browser interpreter 200, however, interprets scripts written in a speech markup language such as VoiceXML rather than a visual markup language. In a preferred embodiment the voice browser 110 may be realized using, consistent with the teachings herein, a voice browser licensed from, for example, Nuance Communications of Menlo Park, Calif.

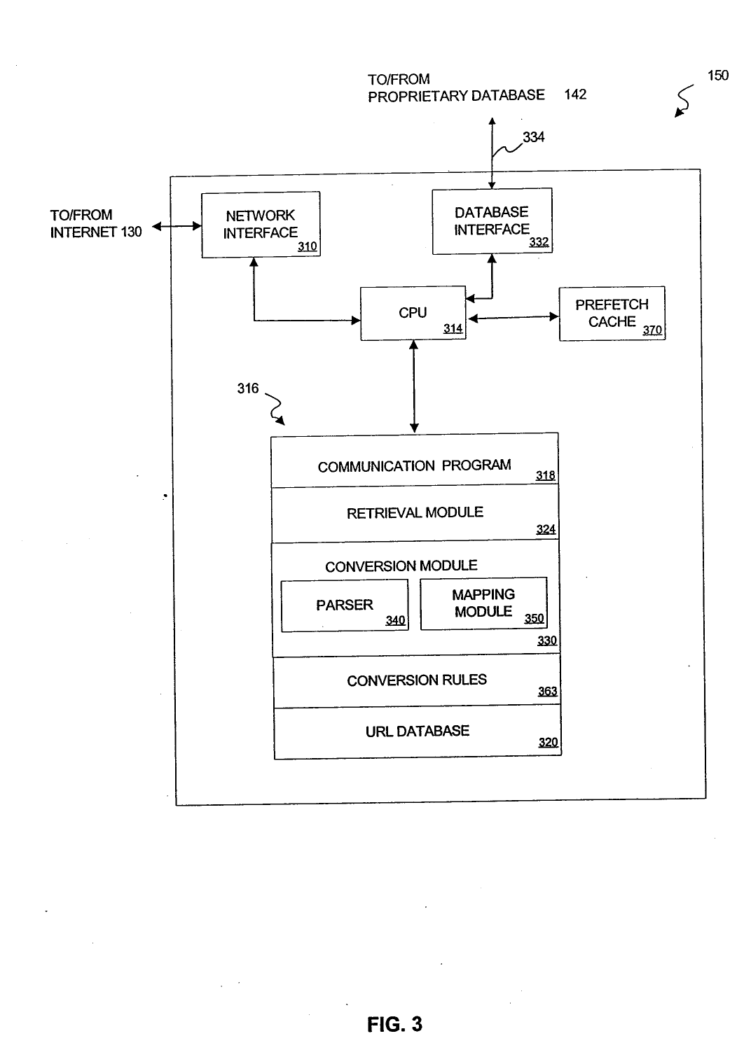

Turning now to FIG. 3, a functional block diagram is provided of the conversion server 150 of the present invention. As is described below, the conversion server 150 operates to convert or transcode conventional structured document formats (e.g., HTML) into the format applicable to the voice browser 110 (e.g., VoiceXML). This conversion is generally effected by performing a predefined mapping of the syntactical elements of conventional structured documents harvested from Web servers 140 into corresponding equivalent elements contained within an XML-based file formatted in accordance with the protocol of the voice browser 110. The resultant XML-based file may include all or part of the “target” structured document harvested from the applicable Web server 140, and may also optionally include additional content provided by the conversion server 150. In the exemplary embodiment the target document is parsed, and identified tags, styles and content can either be replaced or removed.

The conversion server 150 may be physically implemented using a standard configuration of hardware elements including a CPU 314, a memory 316, and a network interface 310 operatively connected to the Internet 130. Similar to the voice browser 110, the memory 316 stores a standard communication program 318 to realize standard network communications via the Internet 130. In addition, the communication program 318 also controls communication occurring between the conversion server 150 and the proprietary database 142 by way of database interface 332. As is discussed below, the memory 316 also stores a set of computer programs to implement the content conversion process performed by the conversion module 150.

Referring to FIG. 3, the memory 316 includes a retrieval module 324 for controlling retrieval of content from Web servers 140 and proprietary database 142 in accordance with browsing requests received from the voice browser 110. In the case of requests for content from Web servers 140, such content is retrieved via network interface 310 from Web pages formatted in accordance with protocols particularly suited to portable, handheld or other devices having limited display capability (e.g., WML, Compact HTML, xHTML and HDML). As is discussed below, the locations or URLs of such specially formatted sites may be provided by the voice browser or may be stored within a URL database 320 of the conversion server 150. For example, if the voice browser 110 receives a request from a user of a subscriber unit for content from the “CNET” Web site, then the voice browser 110 may specify the URL for the version of the “CNET” site accessed by WAP-compliant devices (i.e., comprised of WML-formatted pages). Alternatively, the voice browser 110 could simply proffer a generic request for content from the “CNET” site to the conversion server 150, which in response would consult the URL database 320 to determine the URL of an appropriately formatted site serving “CNET” content.

The memory 316 of conversion server 150 also includes a conversion module 330 operative to convert the content collected under the direction of retrieval module 324 from Web servers 140 or the proprietary database 142 into corresponding VoiceXML documents. As is described below, the retrieved content is parsed by a parser 340 of conversion module 330 in accordance with a document type definition (“DTD”) corresponding to the format of such content. For example, if the retrieved Web page content is formatted in WML, the parser 340 would parse the retrieved content using a DTD obtained from the applicable standards body, i.e., the Wireless Application Protocol Forum, Ltd. (www.wapforum.org) into a parsed file. A DTD establishes a set of constraints for an XML-based document; that is, a DTD defines the manner in which an XML-based document is constructed. The resultant parsed file is generally in the form of a Domain Object Model (“DOM”) representation, which is arranged in a tree-like hierarchical structure composed of a plurality of interconnected nodes (i.e., a “parse tree”). In the exemplary embodiment the parse tree includes a plurality of “child” nodes descending downward from its root node, each of which are recursively examined and processed in the manner described below.

A mapping module 350 within the conversion module 330 then traverses the parse tree and applies predefined conversion rules 363 to the elements and associated attributes at each of its nodes. In this way the mapping module 350 creates a set of corresponding equivalent elements and attributes conforming to the protocol of the voice browser 110. A converted document file (e.g., a VoiceXML document file) is then generated by supplementing these equivalent elements and attributes with grammatical terms to the extent required by the protocol of the voice browser 110. This converted document file is then provided to the voice browser 110 via the network interface 310 in response to the browsing request originally issued by the voice browser 110.

The conversion module 330 is preferably a general purpose converter capable of transforming the above-described structured document content (e.g., WML) into corresponding VoiceXML documents. The resultant VoiceXML content can then be delivered to users via any VoiceXML-compliant platform, thereby introducing a voice capability into existing structured document content. In a particular embodiment, a basic set of rules can be imposed to simplify the conversion of the structured document content into the VoiceXML format. An exemplary set of such rules utilized by the conversion module 330 may comprise the following.
1. Certain aspects of the resultant VoiceXML content may be generated in accordance with the values of one or more configurable parameters.
2. If the structured document content (e.g., WML pages) comprises images, the conversion module 330 will discard the images and generate the necessary information for presenting the image.
3. If the structured document content comprises scripts, data or some other component not capable of being presented by voice, the conversion module 330 may generate appropriate warning messages or the like. The warning message will typically inform the user that the structured content contains a script or some component not capable of being converted to voice and that meaningful information may not be being conveyed to the user.
4. When the structured document content contains instructions similar or identical to those such as the WML-based SELECT LIST options or a set of WML ANCHORS, the conversion module 330 generates information for presenting the SELECT LIST or similar options into a menu list for audio representation. For example, an audio playback of “Please say news weather mail” could be generated for the SELECT LIST defining the three options of news, weather and mail. The individual elements of a WML-based SELECT LIST or the set of WML ANCHORS (<a> tag) may be presented in an audio mode in succession, with the user traversing through the list of elements from the SELECT LIST/ANCHORS using conventional audio commands (e.g., “next”, “previous”, and using “OK” to select the element). This approach is particularly advantageous in cases in which lengthy lists of elements are involved, as user confusion could ensue if all such elements are concurrently provided to the user.
5. Any hyperlinks in the structured document content are converted to reference the conversion module 330, and the actual link location passed to the conversion module as a parameter to the referencing hyperlink. In this way hyperlinks and other commands which transfer control may be voice-activated and converted to an appropriate voice-based format upon request.
6. Input fields within the structured content are converted to an active voice-based dialogue, and the appropriate commands and vocabulary added as necessary to process them.
7. Multiple screens of structured content (e.g., card-based WML screens) can be directly converted by the conversion module 330 into forms or menus of sequential dialogs. Each menu is a stand-alone component (e.g., performing a complete task such as receiving input data). The conversion module 330 may also include a feature that permits a user to interrupt the audio output generated by a voice platform (e.g., BeVocal, HeyAnita) prior to issuing a new command or input.
8. For all those events and “do” type actions similar to WML-based “OK”, “Back” and “Done” operations, voice-activated commands may be employed to straightforwardly effect such actions.
9. In the exemplary embodiment the conversion module 330 operates to convert an entire page of structured content at once and to play the entire page in an uninterrupted manner. This enables relatively lengthy structured documents to be presented without the need for user intervention in the form of an audible “More” command or the equivalent.

An overview of the operation of the system 100 will now be provided in order to facilitate understanding of the functionality of the conversion server 150 of the present invention. Upon receipt of a request for Web content at the voice browser 110, an initial check is performed to determine whether the requested Web content is of a format consistent with its own format (e.g., VoiceXML). If so, then the voice browser 110 may directly retrieve such content from the Web server 140 hosting the Web site containing the requested content (e.g., “vxml.cnet.com”) in a manner consistent with the applicable voice-based protocol. If the requested content is provided by a Web site (e.g., “cnet.com”) formatted inconsistently with the voice browser 110, then the intelligence of the voice browser 110 influences the course of subsequent processing. Specifically, in the case where the voice browser 110 maintains a database (not shown) of Web sites having formats similar to its own, then the voice browser 110 forwards the identity of such similarly formatted site (e.g., “wap.cnet.com”) to the inventive conversion server 150 via the Internet 130. If such a database is not maintained by the voice browser 110, then the identity of the requested Web site itself (e.g., “cnet.com”) is similarly forwarded to the conversion server 150 via the Internet 130. In the latter case the conversion server 150 will recognize that the format of the requested Web site (e.g., HTML) is dissimilar from the protocol of the voice browser 110, and will then access the URL database 320 in order to determine whether there exists a version of the requested Web site of a format (e.g., WML) more easily convertible into the protocol of the voice browser 110. In this regard it has been found that display protocols adapted for the limited visual displays characteristic of handheld or portable devices (e.g., WAP, HDML, iMode, Compact HTML or XML) are most readily converted into generally accepted voice-based protocols (e.g., VoiceXML), and hence the URL database 320 will generally include the URLs of Web sites comporting with such protocols. Once the conversion server 150 has determined or been made aware of the identity of the requested Web site or of a corresponding Web site of a format more readily convertible to that of the voice browser 110, the conversion server 150 retrieves and converts Web content from such requested or similarly formatted site in the manner described below.

In an exemplary implementation, the voice-browser 110 will be configured to use substantially the same syntactical elements in requesting the conversion server 150 to obtain content from Web sites not formatted in conformance with the applicable voice-based protocol as are used in requesting content from Web sites compliant with the protocol of the voice browser 110. In the case where the voice browser 110 operates in accordance with the VoiceXML protocol, it may issue requests to Web servers 140 compliant with the VoiceXML protocol using, for example, the syntactical elements goto, choice, link and submit. As is described below, the voice browser 110 may be configured to request the conversion server 150 to obtain content from inconsistently formatted Web sites using these same syntactical elements. For example, the voice browser 110 could be configured to issue the following type of goto when requesting Web content through the conversion server 150:

<goto next=http://ConSeverAddress:port/Filename?URL=ContentAddress&Protocol/>

where the variable ConSeverAddress within the next attribute of the goto element is set to the IP address of the conversion server 150, the variable Filename is set to the name of a conversion script (e.g., conversion.jsp) stored on the conversion server 150, the variable ContentAddress is used to specify the destination URL (e.g., “wap.cnet.com”) of the Web server 140 of interest, and the variable Protocol identifies the format (e.g., WAP) of such Web server. The conversion script is typically embodied in a file of conventional format (e.g., files of type “.jsp”, “.asp” or “.cgi”). Once this conversion script has been provided with this destination URL, the conversion server 150 retrieves Web content from the applicable Web server 140 and the conversion script converts the retrieved content into the VoiceXML format in the manner described below.

The voice browser 110 may also request Web content from the conversion server 150 using the Choice element defined by the VoiceXML protocol. Consistent with the VoiceXML protocol, the Choice element is utilized to define potential user responses to queries posed within a Menu construct. In particular, the Menu construct provides a mechanism for prompting a user to make a selection, with control over subsequent dialogue with the user being changed on the basis of the user's selection. The following is an exemplary call for Web content which could be issued by the voice browser 110 to the conversion server 150 using the Choice element:

<choice
next=“http://ConSeverAddress:port/Conversion.jsp?URL=
ContentAddress&Protocol/”>

The voice browser 110 may also request Web content from the conversion server 150 using the link element, which may be defined in a VoiceXML document as a child of the vxml or form constructs. An example of such a request based upon a link element is set forth below:

<link next=“Conversion.jsp?URL=ContentAddress&Protocol/”>

Finally, the submit element is similar to the goto element in that its execution results in procurement of a specified VoiceXML document. However, the submit element also enables an associated list of variables to be submitted to the identified Web server 140 by way of an HTTP GET or POST request. An exemplary request for Web content from the conversion server 150 using a submit expression is given below:

<submit
next=“htttp://http://ConSeverAddress:port//Conversion.jsp?URL=
ContentAddress&Protocol method=””post” namelist=“site protocol” />

where the method attribute of the submit element specifies whether an HTTP GET or POST method will be invoked, and where the namelist attribute identifies a site protocol variable forwarded to the conversion server 150. The site protocol variable is set to the formatting protocol applicable to the Web site specified by the ContentAddress variable.

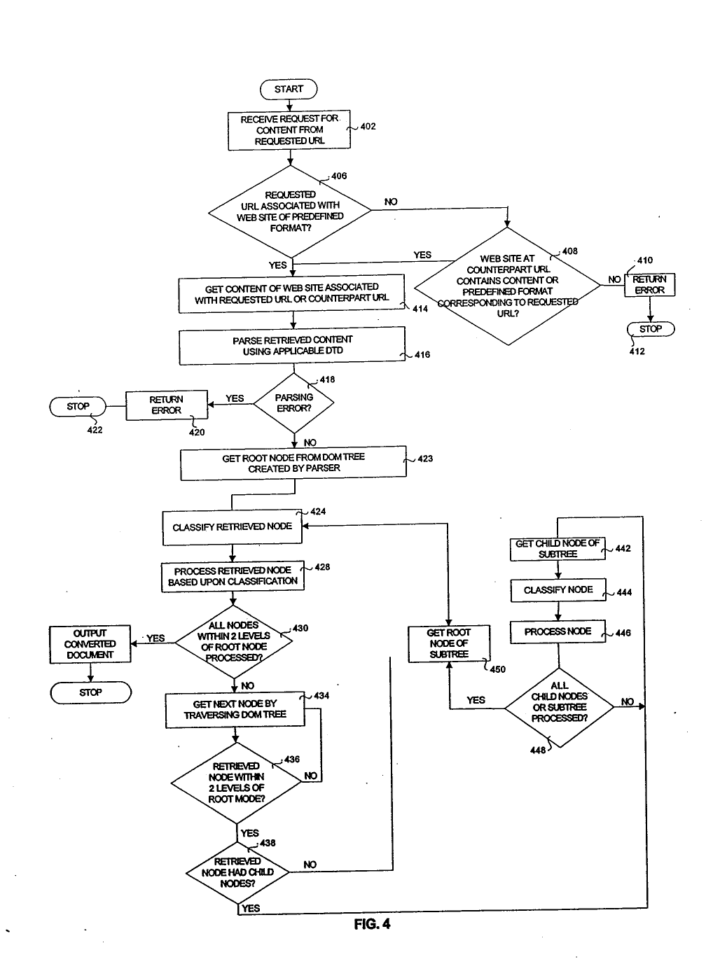

FIG. 4 is a flow chart representative of operation of the conversion server 150 in accordance with the present invention. A source code listing of a top-level convert routine forming part of an exemplary software implementation of the conversion operation illustrated by FIG. 4 is contained in Appendix A. In addition, Appendix B provides an example of conversion of a WML-based document into VoiceXML-based grammatical structure in accordance with the present invention. Referring to step 402 of FIG. 4, the network interface 310 of the conversion server 150 receives one or more requests for Web content transmitted by the voice browser 110 via the Internet 130 using conventional Internet protocols (i.e., HTTP and TCP/IP). The conversion module 330 then determines whether the format of the requested Web site corresponds to one of a number of predefined formats (e.g., WML) readily convertible into the protocol of the voice browser 110 (step 406). If not, then the URL database 320 is accessed in order to determine whether there exists a version of the requested Web site formatted consistently with one of the predefined formats (step 408). If not, an error is returned (step 410) and processing of the request for content is terminated (step 412). Once the identity of the requested Web site or of a counterpart Web site of more appropriate format has been determined, Web content is retrieved by the retrieval module 310 of the conversion server 150 from the applicable Web server 140 hosting the identified Web site (step 414).

Once the identified Web-based or other content has been retrieved by the retrieval module 310, the parser 340 is invoked to parse the retrieved content using the DTD applicable to the format of the retrieved content (step 416). In the event of a parsing error (step 418), an error message is returned (step 420) and processing is terminated (step 422). A root node of the DOM representation of the retrieved content generated by the parser 340, i.e., the parse tree, is then identified (step 423). The root node is then classified into one of a number of predefined classifications (step 424). In the exemplary embodiment each node of the parse tree is assigned to one of the following classifications: Attribute, CDATA, Document Fragment, Document Type, Comment, Element, Entity Reference, Notation, Processing Instruction, Text. The content of the root node is then processed in accordance with its assigned classification in the manner described below (step 428). If all nodes within two tree levels of the root node have not been processed (step 430), then the next node of the parse tree generated by the parser 340 is identified (step 434). If not, conversion of the desired portion of the retrieved content is deemed completed and an output file containing such desired converted content is generated.

If the node of the parse tree identified in step 434 is within two levels of the root node (step 436), then it is determined whether the identified node includes any child nodes (step 438). If not, the identified node is classified (step 424). If so, the content of a first of the child nodes of the identified node is retrieved (step 442). This child node is assigned to one of the predefined classifications described above (step 444) and is processed accordingly (step 446). Once all child nodes of the identified node have been processed (step 448), the identified node (which corresponds to the root node of the subtree containing the processed child nodes) is itself retrieved (step 450) and assigned to one of the predefined classifications (step 424).

Appendix C contains a source code listing for a TraverseNode function which implements various aspects of the node traversal and conversion functionality described with reference to FIG. 4. In addition, Appendix D includes a source code listing of a ConvertAtr function, and of a ConverTag function referenced by the TraverseNode function, which collectively operate to WML tags and attributes to corresponding VoiceXML tags and attributes.

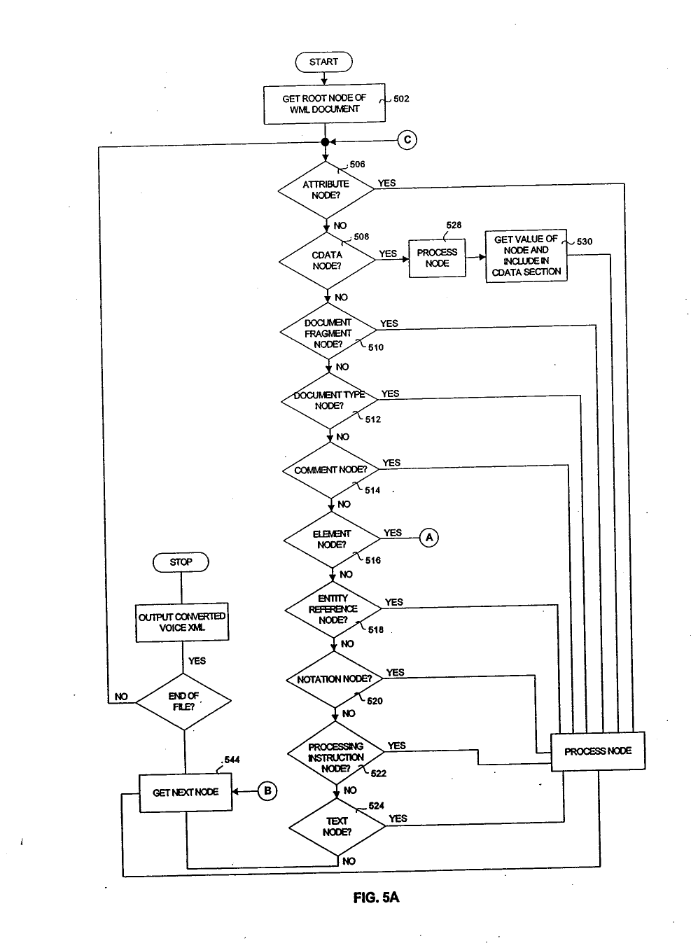

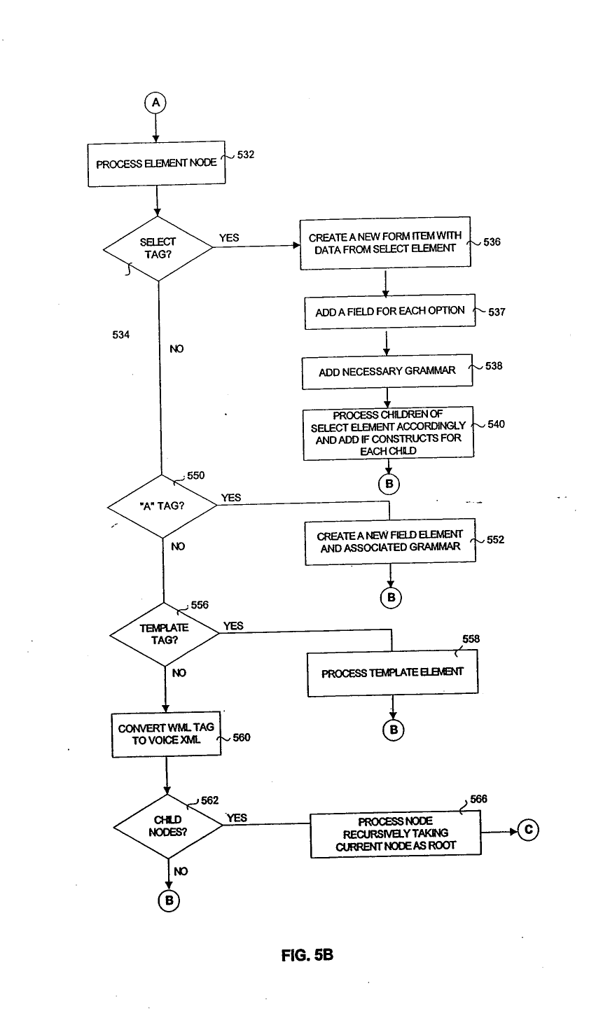

FIGS. 5A and 5B are collectively a flowchart illustrating an exemplary process for transcoding a parse tree representation of an WML-based document into an output document comporting with the VoiceXML protocol. Although FIG. 5 describes the inventive transcoding process with specific reference to the WML and VoiceXML protocols, the process is also applicable to conversion between other visual-based and voice-based protocols. In step 502, a root node of the parse tree for the target WML document to be transcoded is retrieved. The type of the root node is then determined and, based upon this identified type, the root node is processed accordingly. Specifically, the conversion process determines whether the root node is an attribute node (step 506), a CDATA node (step 508), a document fragment node (step 510), a document type node (step 512), a comment node (step 514), an element node (step 516), an entity reference node (step 518), a notation node (step 520), a processing instruction node (step 522), or a text node (step 524).

In the event the root node is determined to reference information within a CDATA block, the node is processed by extracting the relevant CDATA information (step 528). In particular, the CDATA information is acquired and directly incorporated into the converted document without modification (step 530). An exemplary WML-based CDATA block and its corresponding representation in VoiceXML is provided below.

WML-Based CDATA Block

```
<?xml version=“1.0” ?>
<!DOCTYPE wml PUBLIC “-//WAPFORUM//DTD WML 1.1//EN”
“http://www.wapforum.org/DTD/wml_1.1.xml” >
<wml>
  <card>
      <p>
          <![CDATA[
              .....
              .....
              .....
          ]]>
      </p>
  </card>
</wml>
```

VoiceXML Representation of CDATA Block

```
<?xml version=“1.0” ?>
<vxml>
    <form>
        <block>
            <![CDATA[
                .....
                .....
                .....
            ]]>
        </block>
    </form>
</vxml>
```

If it is established that the root node is an element node (step 516), then processing proceeds as depicted in FIG. 5B (step 532). If a Select tag is found to be associated with the root node (step 534), then a new VoiceXML form is created based upon the data comprising the identified select tag (step 536). For each select option a field is added (step 537). The text in the option tag is put inside the prompt tag and the soft keys defined in the source WML are converted into grammar for the field. If soft keys are not defined in the source WML, grammar for the “OK” operation is added by default. In addition, grammar for “next” and “previous” operations is also added in order to facilitate traversal through the elements of the SELECT tag (538).

In accordance with the invention, the operations defined by the WML-based Select tag are mapped to corresponding operations presented through the VoiceXML-based form and field tags. The Select tag is typically utilized to specify a visual list of user options and to define corresponding actions to be taken depending upon the option selected. Similarly, the form and field tags are defined in order to create a similar voice document disposed to cause actions to be performed in response to spoken prompts. A form tag in VoiceXML specifies an introductory message and a set of spoken prompts corresponding to a set of choices. The Field tag consists of “if” constructs and specifies a corresponding set of possible responses to the prompts, and will typically also specify a goto tag having a URL to which a user is directed upon selecting a particular choice (step 540). When afield is visited, its introductory text is spoken, the user is prompted in accordance with its options, and the grammar for the field becomes active. In response to input from the user, the appropriate if construct is executed and the corresponding actions performed.

The following exemplary code corresponding to a WML-based Select operation and a corresponding VoiceXML-based Field operation illustrate this conversion process. Each operation facilitates presentation of a set of four potential options for selection by a user: “cnet news”, “BBC”, “Yahoo stocks”, and “Wireless Knowledge”

Select operation

```
<select ivalue=”1” name=”action”>
    <option title=”OK” onpick=”http://cnet.news.com>Cnet
    news</option>
    <option title=”OK” onpick=”http://mobile.bbc.com>BBC/option>
    <option title=”OK” onpick=”http://stocks.yahoo.com>Yahoo
    stocks</option>
    <option  title=”OK” onpick=”http://www.wireless-
    knowledge.com”>Visit  Wireless Knowledge</option>
</select>
```

Form-Field operation

```
<form id=“mainMenu”>
  <field name=“NONAME0”>
    <prompt> Cnet news </prompt>
    <prompt> Please Say ok or next </prompt>
    <grammar>
      [ ok next ]
    </grammar>
    <filled>
      <if cond=“NONAME0 == ‘ok’ ”>
      <goto next=“ http://mmgc:port/Convert.jsp?url=
      http://cnet.news.com ”/>
      <else/>
        <prompt> next </prompt>
      </if>
    </filled>
  </field>
  <field name=“NONAME1”>
    <prompt> BBC </prompt>
    <prompt> Please Say ok or next </prompt>
    <grammar>
      [ ok next ]
    </grammar>
    <filled>
      <if cond=“NONAME1 == ‘ok’ ”>
      <goto next=“ http://mmgc:port/Convert.jsp?url=
      http://mobile.bbc.com ”/>
      <else/>
        <prompt> next </prompt>
      </if>
    </filled>
  </field>
  <field name=“NONAME2”>
    <prompt> Yahoo stocks </prompt>
    <prompt> Please Say ok or next </prompt>
    <grammar>
      [ ok next ]
    </grammar>
    <filled>
      <if cond=“NONAME2 == ‘ok’ ”>
      <goto  next=“  http://mmgc:port/Convert.jsp?url=
      http://www.wirelessknowledge.com ”/>
      </if>
    </filled>
  </field>
</form>
```

When a user initiates a session using the voice browser 110, a top-level menu served by a main menu routine is heard first by the user. The field tags inside the form tag for such routine build a list of words, each of which is identified by a different field tag (e.g., “Cnet news”, “BBC”, “Yahoo stocks”, and “Visit Wireless Knowledge”). When the voice browser 110 visits this form, the Prompt tag then causes it to prompt the user with the first option from the applicable SELECT LIST. The voice browser 110 plays each option from the SELECT LIST one by one and waits for the user response. Once the form has been loaded by the voice browser 110, the user may select any of the choices by saying OK in response to the prompt played by the voice browser 110. The user may say “next” or “previous” in voice to navigate through the options available in the form. For example, the allowable commands may include a prompt “CNET NEWS” followed by “Please say OK, next, previous”. The “OK” command is used to select the current option. The “next” and “previous” commands are used to browse other options (e.g., “V-enable”, “Yahoo Stocks” and “Wireless Knowledge”). After the user has voiced the “OK” selection, the voice browser 110 will visit the target URL specified by the relevant attribute associated with the selected choice (e.g., “CNET news”). In performing the required conversion, the URL address specified in the onpick attribute of the selected Option tag is passed as an argument to the Convertjsp process in the next attribute of the Choice tag. The Convert.jsp process then converts the content specified by the URL address into well-formatted VoiceXML. The format of a set of URL addresses associated with each of the choices defined by the foregoing exemplary main menu routine are set forth below:

Cnet news ---> http://mmgc:port/Convert.jsp?url=http://cnet.news.com
V-enable ---> http://mmgc:port/Convert.jsp?url=http://www.v-enable.com
Yahoo stocks---> http://mmgc:port/Convert.jsp?url=
http://stocks.yahoo.com
Visit Wireless Knowledge -->
http://mmgc:port/Convert.jsp?url=http://www.wirelessknowledge.com

Referring again to FIG. 5, any “child” tags of the Select tag are then processed as was described above with respect to the original “root” node of the parse tree and accordingly converted into VoiceXML-based grammatical structures (step 540). Upon completion of the processing of each child of the Select tag, the information associated with the next unprocessed node of the parse tree is retrieved (step 544). To the extent an unprocessed node was identified in step 544 (step 546), the identified node is processed in the manner described above beginning with step 506.

Referring again to step 540, an XML-based tag (including, e.g., a Select tag) may be associated with one or more subsidiary “child” tags. Similarly, every XML-based tag (except the tag associated with the root node of a parse tree) is also associated with a parent tag. The following XML-based notation exemplifies this parent/child relationship:

```
<parent>
    <child1>
        <grandchild1> ..... </grandchild1>
    </child1>
    <child2>
        .....
    </child2>
</parent>
```

In the above example the parent tag is associated with two child tags (i.e., child1 and child2). In addition, tag child1 has a child tag denominated grandchild1. In the case of exemplary WML-based Select operation defined above, the Select tag is the parent of the Option tag and the Option tag is the child of the Select tag. In the corresponding case of the VoiceXML-based Menu operation, the Prompt and Choice tags are children of the Menu tag (and the Menu tag is the parent of both the Prompt and Choice tags).

Various types of information are typically associated with each parent and child tag. For example, list of various types of attributes are commonly associated with certain types of tags. Textual information associated with a given tag may also be encapsulated between the “start” and “end” tagname markings defining a tag structure (e.g., “</tagname>”), with the specific semantics of the tag being dependent upon the type of tag. An accepted structure for a WML-based tag is set forth below:

<tagname attribute1=value attribute2=value . . . > text information </tagname>.

Applying this structure to the case of the exemplary WML-based Option tag described above, it is seen to have the attributes of title and onpick. The title attribute defines the title of the Option tag, while the option attribute specifies the action to be taken if the Option tag is selected. This Option tag also incorporates descriptive text information presented to a user in order to facilitate selection of the Option.

Referring again to FIG. 5B, if an “A” tag is determined to be associated with the element node (step 550), then a new field element and associated grammar are created (step 552) in order to process the tag based upon its attributes. Upon completion of creation of this new field element and associated grammar, the next node in the parse tree is obtained and processing is continued at step 544 in the manner described above. An exemplary conversion of a WML-based A tag into a VoiceXML-based Field tag and associated grammar is set forth below:

WML File with “A” tag

```
<?xml version=“1.0”?>
<!DOCTYPE wml PUBLIC “-//WAPFORUM//DTD WML 1.1//EN”
“http://www.wapforum.org/DTD/wml_1.1.xml”>
<wml>
  <card id=“test” title=“Test”>
      <p>This is a test</p>
      <p>
          <A title=“Go” href=“test.wml”> Hello </A>
      </p>
  </card>
</wml>
Here “A” tag has
    1. Title = “go”
    2. href = “test.wml”
    3. Display on screen: Hello [the content between
    <A ..> </A> is displayed on screen]
```

Converted VXML with Field Element

```
<?xml version=“1.0”?>
<vxml>
  <form id=“test”>
  <block>This is a test</block>
  <block>
    <field name=“act”>
      <prompt> Hello </prompt>
      <prompt> Please say OK or Next </prompt>
    <grammar>
    [ ok next ]
    </grammar>
    <filled>
    <if cond=“act == ‘ok’”>
        <goto next=“test.wml” />
    </if>
    </filled>
    </field>
  </block>
  </card>
</vxml>
```

In the above example, the WML-based textual representation of “Hello” and “Next” are converted into a VoiceXML-based representation pursuant to which they are audibly presented. If the user utters “Hello” in response, control passes to the same link as was referenced by the WML “A” tag. If instead “Next” is spoken, then VoiceXML processing begins after the “</field>” tag.

If a Template tag is found to be associated with the element node (step 556), the template element is processed by converting it to a VoiceXML-based Link element (step 558). The next node in the parse tree is then obtained and processing is continued at step 544 in the manner described above. An exemplary conversion of the information associated with a WML-based Template tag into a VoiceXML-based Link element is set forth below.

Template Tag

```
<?xml version=“1.0”?>
<!DOCTYPE wml PUBLIC “-//WAPFORUM//DTD WML 1.1//EN”
“http://www.wap/wml_1.1.xml”>
<wml>
  <template>
      <do type=“options” label=“Main”>
      <go href=“next.wml”/>
      </do>
  </template>
  <card>
      <p> hello </p>
  </card>
</wml>
```

Link Element

```
<?xml version=“1.0”?>
<vxml>
  <link caching=“safe” next=“next.wml”>
      <grammar>
          [(Main)]
      </grammar>
  </link>
  <form>
      <block> hello </block>
  </form>
</wml>
```

In the event that a WML tag is determined to be associated with the element node, then the WML tag is converted to VoiceXML (step 560).

If the element node does not include any child nodes, then the next node in the parse tree is obtained and processing is continued at step 544 in the manner described above (step 562). If the element node does include child nodes, each child node within the subtree of the parse tree formed by considering the element node to be the root node of the subtree is then processed beginning at step 506 in the manner described above (step 566).

APPENDIX A

| | | |
|---|---|---|
| /* | | |
| * Function | : | convert |
| * | | |
| * Input | : | filename, document base |
| * | | |
| * Return | : | None |
| * | | |
| * Purpose | : | parses the input wml file and converts it into vxml file. |

| * | | |
|---|---|---|
| */ | | |
| public void convert(String fileName,String base) | | |
| { | | |
| try { | | |
| Document doc; | | |
| Vector problems = new Vector( ); | | |
| documentBase = base; | | |
| try { | | |
| VXMLErrorHandler errorhandler = | | |
| new VXMLErrorHandler(problems); | | |
| DocumentBuilderFactory | docBuilderFactory | = |
| DocumentBuilderFactory.newInstance( ); | | |
| DocumentBuilder | docBuilder | = |

```
docBuilderFactory.newDocumentBuilder( );
        doc = docBuilder.parse (new File (fileName));
          TraverseNode(doc);
          if (problems.size( ) > 0){
              Enumeration enum = problems.elements( );
              while(enum.hasMoreElements( ))
                  out.write((String)enum.nextElement( ));
          }
    } catch (SAXParseException err) {
        out.write (“** Parsing error”
          + “, line ” + err.getLineNumber ( )
          + “, uri ” + err.getSystemId ( ));
        out.write(“ ” + err.getMessage ( ));
    } catch (SAXException e) {
        Exception  x = e.getException ( );
        ((x == null) ? e : x).printStackTrace ( );
    } catch (Throwable t) {
        t.printStackTrace ( );
    }
    } catch (Exception err) {
        err.printStackTrace ( );
      }
}
```

### Exemplary WML to VoiceXML Conversion

WML to VoiceXML Mapping Table

The following set of WML tags may be converted to VoiceXML tags of analogous function in accordance with Table B1 below.

TABLE B1

| WML Tag | VoiceXML Tag |
|---|---|
| Access | Access |
| Card | Form |
| Head | Head |
| Meta | Meta |
| Wml | Vxml |
| Br | Break |
| P | Block |
| Exit | Disconnect |
| A | Link |
| Go | Goto |
| Input | Field |
| Setvar | Var |

Mapping of Individual WML Elements to Blocks of VoiceXML Elements

In an exemplary embodiment a VoiceXML-based tag and any required ancillary grammar is directly substituted for the corresponding WML-based tag in accordance with Table A1. In cases where direct mapping from a WML-based tag to a VoiceXML tag would introduce inaccuracies into the conversion process, additional processing is required to accurately map the information from the WML-based tag into a VoiceXML-based grammatical structure comprised of multiple VoiceXML elements. For example, the following exemplary block of VoiceXML elements may be utilized to emulate the functionality of the to the WML-based Template tag in the voice domain.

WML-Based Template Element

```
<?xml version=“1.0”?>
<!DOCTYPE  wml  PUBLIC
“-//WAPFORUM//DTD  WML  1.1//EN”
“http://www.wapforum.org/DTD/wml_1.1.xml”>
<wml>
<template>
    <do type=“options” label=“DONE”>
      <go href=“test.wml”/>
    </do>
  </template>
  <card>
        <p align=“left”>Test</p>
<select name=“newsitem”>
        <option onpick=“test1.wml”>Test1 </option>
      <option onpick=“test2.wml”>Test2</option>
      </select>
  </card>
</wml>
```

Corresponding Block of VoiceXML Elements

```
<?xml version=“1.0” ?>
<vxml version=“1.0”>
  <form>
    <field name=“NONAME0”>
      <prompt> test1 </prompt>
      <prompt> Please Say ok or next </prompt>
      <grammar>
        [ ok next done ]
      </grammar>
      <filled>
        <if cond=“NONAME0 == ‘ok’ ”>
```

| | |
|---|---|
| <goto | next=“ |

```
        http:/mmgc.port/Convert.jsp?url=http://server_add/test1.wml”/>
        <else if cond=“NONAME0 == ‘done’ ”/>
```

| | |
|---|---|
| <goto | next=“ |

```
        http://mmgc.port/Convert.jsp?url=http://server_add/test.wml”/>
        <else/>
          <prompt> next </prompt>
        </if>
      </filled>
    </field>
    <field name=“NONAME1”>
      <prompt> test2 </prompt>
      <prompt> Please Say ok or next </prompt>
      <grammar>
        [ ok next ]
      </grammar>
      <filled>
        <if cond=“NONAME1 == ‘ok’ ”>
```

| | |
|---|---|
| <goto | next=“ |

```
        http://mmgc.port/Convert.jsp?url=
        http://server_add/test2.wml ”/>
        <else if cond=“NONAME1 == ‘done’ ”/>
```

| | |
|---|---|
| <goto | next=“ |

```
        http://mmgc.port/Convert.jsp?url=http.//server_add/test.wml”/>
        <else/>
          <prompt> next </prompt>
        </if>
      </filled>
    </field>
  </form>
</vxml>
```

Example of Conversion of Actual WML Code to VoiceXML Code

Exemplary WML Code

```
<?xml version=“1.0”?>
<!DOCTYPE  wml  PUBLIC  “-//WAPFORUM//DTD  WML  1.1//EN”
“http://www.wapforum.org/DTD/wml_1.1.xml”>
<!-- Deck Source: “http://wap.cnet.com” -->
<!-- DISCLAIMER: This source was generated from parsed binary WML content. -->
<!-- This representation of the deck contents does not necessarily preserve -->
<!-- original whitespace or accurately decode any CDATA Section contents, -->
<!-- but otherwise is an accurate representation of the original deck contents -->
<!-- as determined from its WBXML encoding. If a precise representation is required, -->
<!-- then use the “Element Tree” or, if available, the “Original Source” view. -->
<wml>
  <head>
  <meta http-equiv=“Cache-Control” content=“must-revalidate”/>
  <meta http-equiv=“Expires” content=“Tue, 01 Jan 1980 1:00:00 GMT”/>
  <meta http-equiv=“Cache-Control” content=“max-age=0”/>
  </head>
  <card title=“Top Tech News”>
  <p align=“left”>
  CNET News.com
  </p>
  <p mode=“nowrap”>
  <select name=“categoryId” ivalue=“1”>
    <option  onpick=“/wap/news/briefs/0,10870,0-1002-903-1-0,00.wml”>Latest  News
Briefs</option>
    <option onpick=“/wap/news/0,10716,0-1002-901,00.wml”>Latest News Headlines</option>
    <option onpick=“/wap/news/0,10716,0-1007-901,00.wml”>E-Business</option>
    <option onpick=“/wap/news/0,10716,0-1004-901,00.wml”>Communications</option>
    <option onpick=“/wap/news/0,10716,0-1005-901,00.wml”>Entertainment and Media</option>
    <option onpick=“/wap/news/0,10716,0-1006-901,00.wml”>Personal Technology</option>
    <option onpick=“/wap/news/0,10716,0-1003-901,00.wml”>Enterprise Computing</option>
  </select>
  </p>
  </card>
</wml>
```

Corresponding VoiceXML code

```
<?xml version=“1.0” ?>
<vxml version=“1.0”>
  <form>
    <prompt> CNET News.com </prompt>
    <field name=“NONAME0”>
      <prompt> latest news briefs </prompt>
      <prompt> Please Say ok or next </prompt>
      <grammar>
        [ ok next done ]
      </grammar>
      <filled>
        <if cond=“NONAME0 == ‘ok’ ”>
        <goto next=“ http://mmgc:port/Convert.jsp?url=
        http://wap.cnet.com/wap/news/briefs/0,10870,0-1002-903-
        1-0,00.wml” />
        <else/>
          <prompt> next </prompt>
        </if>
      </filled>
    </field>
    <field name=“NONAME1”>
      <prompt> latest news headlines </prompt>
      <prompt> Please Say ok or next </prompt>
      <grammar>
        [ ok next ]
      </grammar>
      <filled>
        <if cond=“NONAME1 == ‘ok’ ”>
        <goto next=“http://mmgc:port
        /Convert.jsp?url=http://wap.cnet.com/wap/news/0,10716,0-1002-
        901,00.wml ”/>
        <else/>
          <prompt> next </prompt>
        </if>
      </filled>
    </field>
    <field name=“NONAME2”>
      <prompt> e-business </prompt>
      <prompt> Please Say ok or next </prompt>
      <grammar>
        [ ok next ]
      </grammar>
      <filled>
        <if cond=“NONAME2 == ‘ok’ ”>
        <goto  next= “ http://  mmgc:port
        /Convert.jsp?url=http://wap.cnet.com/wap/news/0,10716,0-1007-
        901,00.wml ”/>
        <else/>
          <prompt> next </prompt>
        </if>
      </filled>
    </field>
    <field name=“NONAME3”>
      <prompt>communications </prompt>
      <prompt> Please Say ok or next </prompt>
      <grammar>
        [ ok next ]
      </grammar>
      <filled>
        <if cond=“NONAME3 == ‘ok’ ”>
        <goto  next= “ http://  mmgc:port
        /Convert.jsp?url=http://wap.cnet.com/wap/news/0,10716,0-1004-
        901,00.wml ”/>
        <else/>
          <prompt> next </prompt>
        </if>
      </filled>
    </field>
    <field name=“NONAME4”>
      <prompt> entertainment and media </prompt>
      <prompt> Please Say ok or next </prompt>
      <grammar>
        [ ok next ]
      </grammar>
      <filled>
        <if cond=“NONAME4 == ‘ok’ ”>
        <goto  next= “ http://  mmgc:port/Convert.jsp?url=
        http://wap.cnet.com/wap/news/0,10716,0-1005-901,00.wml ”/>
        <else/>
          <prompt> next </prompt>
        </if>
      </filled>
    </field>
    <field name=“NONAME5”>
      <prompt> personal technology </prompt>
      <prompt> Please Say ok or next </prompt>
      <grammar>
        [ ok next ]
      </grammar>
      <filled>
        <if cond=“NONAME5 == ‘ok’ ”>
        <goto  next = “http://  mmgc:port /Convert.jsp?url=
        http://wap.cnet.com/wap/news/0,10716,0-1006-901,00.wml ”/>
        <else/>
          <prompt> next </prompt>
        </if>
      </filled>
    </field>
    <field name=“NONAME6”>
      <prompt> enterprise computing </prompt>
      <prompt> Please Say ok or next </prompt>
      <grammar>
        [ ok next ]
      </grammar>
      <filled>
        <if cond=“NONAME6 == ‘ok’ ”>
        <goto  next= “http:// mmgc:port  /Convert.jsp?url=
        http://wap.cnet.com/wap/news/0,10716,0-1003-901,00.wml ”/>
        <else/>
          <prompt> next </prompt>
        </if>
      </filled>
    </field>
  </form>
</vxml>
  <! END OF CONVERSION >
```

APPENDIX C

| | | |
|---|---|---|
| /* | | |
| * Function | : | TraverseNode |
| * | | |
| * Input | : | Node |
| * | | |
| * Return | : | None |
| * | | |
| * Purpose | : | Traverse's the Dom tree node by node and converts the |
| * | | tag and attributes into equivalent vxml tags and attributes. |

```
*
*/
  void TraverseNode(Node el){
    StringBuffer buffer = new StringBuffer( );
    if (el == null)
      return;
    int type = el.getNodeType( );
    switch (type){
      case Node.ATTRIBUTE_NODE: {
          break;
        }
      case Node.CDATA_SECTION_NODE: {
          buffer.append(“<![CDATA[”);
          buffer.append(el.getNodeValue( ));
          buffer.append(“]]>”);
          writeBuffer(buffer);
          break;
        }
      case Node.DOCUMENT_FRAGMENT_NODE: {
          break;
        }
      case Node.DOCUMENT_NODE: {
          TraverseNode(((Document)el).getDocumentElement( ));
          break;
        }
      case Node.DOCUMENT_TYPE_NODE : {
          break;
        }
      case Node.COMMENT_NODE: {
          break;
        }
      case Node.ELEMENT_NODE: {
        if (el.getNodeName( ).equals(“select”)){
            processMenu(el);
          }else if (el.getNodeName( ).equals(“a”)){
            processA(el);
          } else {
          buffer.append(“<”);
          buffer.append(ConvertTag(el.getNodeName( )));
          NamedNodeMap nm = el.getAttributes( );
          if (first){
            buffer.append(“ version=\“1.0\””);
            first=false;
          }
          int len = (nm != null) ? nm.getLength( ) : 0;
          for (int j =0; j < len; j++){
            Attr attr = (Attr)nm.item(j);
buffer.append(ConvertAtr(el.getNodeName( ),attr.getNodeName( ),
attr.getNodeValue( )));
          }
          NodeList nl = el.getChildNodes( );
          if ((nl == null) ||
            ((len = nl.getLength( )) < 1)){
            buffer.append(“/>”);
            writeBuffer(buffer);
          }else{
            buffer.append(“>”);
            writeBuffer(buffer);
            for (int j=0; j < len; j++)
              TraverseNode(nl.item(j));
            buffer.append(“</”);
            buffer.append(ConvertTag(el.getNodeName( )));
            buffer.append(“>”);
            writeBuffer(buffer);
          }
          }
          break;
        }
      case Node.ENTITY_REFERENCE_NODE : {
          NodeList nl = el.getChildNodes( );
          if (nl != null){
            int len = nl.getLength( );
            for (int j=0; j < len; j++)
              TraverseNode(nl.item(j));
          }
          break;
        }
      case Node.NOTATION_NODE: {
          break;
        }
      case Node.PROCESSING_INSTRUCTION_NODE: {
          buffer.append(“<?”);
          buffer.append(ConvertTag(el.getNodeName( )));
          String data = el.getNodeValue( );
          if ( data != null && data.length( ) > 0 ) {
            buffer.append(“ ”);
            buffer.append(data);
          }
          buffer.append(“ ?>”);
          writeBuffer(buffer);
          break;
        }
      case Node.TEXT_NODE: {
          if (!el.getNodeValue( ).trim( ).equals(“”)){
            try {
out.write(“<prompt>”+el.getNodeValue( ).trim( )+“</prompt>\n”);
            }catch (Exception e){
              e.printStackTrace( );
            }
          }
          break;
        }
    }
  }
/*
```

APPENDIX D

| | | |
|---|---|---|
| /* | | |
| * Function | : | ConvertTag |
| * | | |
| * Input | : | wpa tag |
| * | | |
| * Return | : | equivalent vxml tag |
| * | | |
| * Purpose | : | converts a wml tag to vxml tag using the |
| | | WMLTagResourceBundle. |

```
*
*/
  String ConvertTag(String wapelement){
    ResourceBundle rbd = new WMLTagResourceBundle( );
    try {
      return rbd.getString(wapelement);
    }catch (MissingResourceException e){
      return “”;
    }
  }
/*
```

| | | |
|---|---|---|
| * Function | : | ConvertAtr |
| * | | |
| * Input | : | wap tag, wap attribute, attribute value |
| * | | |
| * Return | : | equivalent vxml attribute with it's value. |
| * | | |
| * Purpose | : | converts the combination of tag+attribute of wml to a vxml |
| * | | attribute using WMLAtrResourceBundle. |

```
*
*/
  String ConvertAtr(String wapelement,String wapattrib,String val){
    ResourceBundle rbd = new WMLAtrResourceBundle( );
    String tempStr=“”;
    String searchTag;
    searchTag =wapelement.trim( )+“-”+wapattrib.trim( );
    try {
      tempStr += “ ”;
      String convTag = rbd.getString(searchTag);
      tempStr += convTag;
      if (convTag.equalsIgnoreCase(“next”))
        tempStr += “=\“”+server+“?url=”+documentBase;
      else
        tempStr += “=\“”;
      tempStr += val;
      tempStr += “\“”;
      return tempStr;
    }catch (MissingResourceException e){
      return “”;
    }
  }
/*
```

| | | |
|---|---|---|
| * Function | : | processMenu |
| * | | |
| * Input | : | Node |
| * | | |
| * Return | : | None |
| * | | |
| * Purpose | : | it converts a select list into an |
| * | | equivalent form in vxml. |

```
*
*/
private void processMenu(Node el) throws MMWMLException{
    String urlStr=“”;
    String prevUrlStr=“”;
    try {
      String firstFormName=null ;
      String menuName=“NONAME” ;
      StringBuffer otherForms = new StringBuffer( );
      boolean firstForm = true;
      int formId = 0;
      String val=“”;
      NamedNodeMap nm = el.getAttributes( );
      int len = (nm != null) ? nm.getLength( ) : 0;
      for (int j =0; j < len; j++){
        Attr attr = (Attr)nm.item(j);
        if (attr.getNodeName( ).equals(“name”)){
          menuName=attr.getNodeValue( );
          break;
        }
      }
      int menuItems = getNodes(el, “option”);
      NodeList nl = el.getChildNodes( );
      len = nl.getLength( );
      for (int j=0; j < len; j++){
        Node el1 = nl.item(j);
        int type = el1.getNodeType( );
        switch (type){
          case Node.ELEMENT_NODE:{
            NamedNodeMap nm1 = el1.getAttributes( );
            int len2 = (nm1 != null) ? nm1.getLength( ) :
            0;
            for (int l =0; l < len2; l++){
              Attr attr1 = (Attr)nm1.item(l);
            if (attr1.getNodeName( ).equals(“value”)){
              val = attr1.getNodeValue( );
              urlStr
              =searchAndReplaceVars(menuName,val);
            }else if
            (attr1.getNodeName( ).equals(“onpick”)){
              val = attr1.getNodeValue( );
              urlStr
              =searchAndReplaceOnpickVars(val);
            }
          }
          NodeList nl1 = el1.getChildNodes( );
          int len1 = nl1.getLength( );
          for (int k=0; k < len1; k++){
          Node el2 = nl1.item(k);
          switch (el2.getNodeType( )){
            case Node.TEXT_NODE:{
              if
              (!el2.getNodeValue( ).trim( ).equals(“”))
              {
                formId++;
                if (firstForm){
                  firstFormName =
                  “Form_”+cardId+“_”+formId;
                  firstForm = false;
                }
                tmpStr=stripSpecialChars(el2.getNode
              Value( ).toLowerCase( ).trim( ));
                otherForms.append(addForm(formId,
                menuItems, menuName,
                val,stripChars(tmpStr),
                urlStr, prevUrlStr));
                prevUrlStr =
                “Form_”+cardId+“_”+formId;
              }
            }
            break;
          }
        }
        break;
      }
    }
}
responseBuffer.append(“\n<goto next=\“#”+firstFormName+“\” />\n”);
responseBuffer.append(“</block>\n</form>\n”);
responseBuffer.append(replaceEntityRef(otherForms.toString( )));
responseBuffer.append(“<form>\n<block>\n”);
this.hasMenu = true;
}catch (Exception e){
    throw new MMWMLException(e,Constants.APP_ERR);
}
}
/**
```

| | | |
|---|---|---|
| * Function | : | addForm |
| * | | |
| * Input | : | formId |
| * Input | : | menuItems |
| * Input | : | val |
| * Input | : | url |
| * Input | : | prevUrl |
| * | | |
| * Return | : | String |
| * | | |
| * Purpose | : | process a menu node. it converts a select list into an |
| * | | equivalent menu in vxml. |
| * | | |
| */ | | |

```
String addForm(int formId,int menuItems,String menuName, String
menuVal,String val,String url, String prevUrl)
        throws MMWMLException {
        String formName = “Form_”+cardId+“_”+formId;
        StringBuffer grammar = new StringBuffer( );
        StringBuffer dtmf = new StringBuffer( );
        StringBuffer prompt = new StringBuffer( );
        StringBuffer ifcond = new StringBuffer( );
        String tmpStr;
        int counter = 0;
        boolean firstTime = true;
        String tmpHref1;
        String tmpHref;
        boolean acceptFound = false;
        long tmpId = grammarId++;
        boolean graStarted= false;
        DoTemplate doTemp = null;
        prompt.append(“<prompt> please say ”);
        graStarted = false;
        grammar.append(“<grammar type=\“application/x-jsgf\” >”);
        dtmf.append(“<dtmf> ”);
        for (counter=0; counter < localDo.size( ); counter++){
          doTemp = (DoTemplate)localDo.elementAt(counter);
          prompt.append(doTemp.label+“ , ”);
          if (graStarted){
            grammar.append(“| (“+doTemp.label+”)
{“+doTemp.label+”}”);
            dtmf.append(“ | “ + counter+” {“+doTemp.label+”}”);
          } else {
            grammar.append(“(“+doTemp.label+”)
{“+doTemp.label+”}”);
            dtmf.append(counter+“ {“+doTemp.label+”} ”);
            graStarted = true;
          }
          if (menuVal.startsWith(“#”)){
            tmpHref=menuVal;
          } else {
            tmpHref = searchAndReplaceOnpickVars(doTemp.href);
            tmpHref1=replaceVariable(tmpHref,menuName,menuVal);
            tmpHref=tmpHref1;
          }
        if (firstTime) {
          ifcond.append(“<if
cond=\“tmpfield==‘“+doTemp.label+”’ \” >”);
          ifcond.append(“<goto
“+ConvertAtr(“option”,“onpick”,tmpHref)+”/>”);
          firstTime = false;
        } else {
          ifcond.append(“<elseif
cond=\“tmpfield==‘“+doTemp.label+”’ \” />”);
          ifcond.append(“<goto
“+ConvertAtr(“option”,“onpick”,tmpHref)+”/>”);
        }
        if (doTemp.type.equals(“accept”)){
          acceptFound = true;
        }
      }
      if (!acceptFound){
        prompt.append(“ ok ”);
        if (graStarted){
          grammar.append(“| (ok) {ok} ”);
          dtmf.append(“ | “ +counter+” {ok} ”);
        } else {
          grammar.append(“(ok) {ok} ”);
          dtmf.append(counter+“ {ok} ”);
          graStarted = true;
        }
        counter++;
        if (firstTime){
          ifcond.append(“<if cond=\“tmpfield==‘ok’\”>”);
          firstTime = false;
        } else {
          ifcond.append(“<elseif cond=\“tmpfield==‘ok’ \” />”);
        }
        ifcond.append(“<goto
“+ConvertAtr(“option”,“onpick”,url)+”/>”);
      }
      if (menuItems == formId){
        if (!prevUrl.equals(“”)){
          prompt.append(“ or Previous ”);
          if (graStarted){
            grammar.append(“ | (previous) {previous}”);
            dtmf.append(“ | “ + counter+” {previous} ”);
          } else {
            grammar.append(“ (previous) {previous}”);
            dtmf.append( counter+“ {previous} ”);
            graStarted = true;
          }
          counter++;
          ifcond.append(“<elseif cond=\“tmpfield==‘previous’ \”/>”);
          ifcond.append(“<goto next=\“#”+prevUrl+“\”/>”);
        }
      } else {
        if (prevUrl.equals(“”)){
          prompt.append(“ or next ”);
          if (graStarted){
            grammar.append(“ | (next) {next} ”);
            dtmf.append(“ | “ + counter+” {next} ”);
          } else {
            grammar.append(“ (next) {next} ”);
            dtmf.append(counter+“ {next} ”);
            graStarted = true;
          }
          counter++;
          ifcond.append(“<else />”);
          ifcond.append(“<goto
next=\“#Form_”+cardId+“_”+(formId+1)+“\”/>”);
        } else {
          prompt.append(“ , next or Previous ”);
          if (graStarted){
            grammar.append(“ | (next) {next} ”);
            dtmf.append(“ | “ + (counter++)+” {next} ”);
            grammar.append(“ | (previous) {previous} ”);
            dtmf.append(“ | “ + counter+” {previous} ”);
          } else {
            grammar.append(“ (next) {next} ”);
            dtmf.append((counter++)+“ {next} ”);
            grammar.append(“ (previous) {previous} ”);
            dtmf.append(counter+“ {previous} ”);
            graStarted = true;
          }
          counter++;
          ifcond.append(“<elseif cond=\“tmpfield==‘previous’ \”/>”);
          ifcond.append(“<goto next=\“#”+prevUrl+“\”/>”);
          ifcond.append(“<else />”);
          ifcond.append(“<goto
next=\“#Form_”+cardId+“_”+(formId+1)+“\”/>”);
        }
      }
      ifcond.append(“</if>”);
      prompt.append(“<audio src=\“”+endOfPrompt+“\”/>”);
      prompt.append(“</prompt>”);
      grammar.append(“</grammar>”);
      dtmf.append(“</dtmf>”);
      StringBuffer buffer = new StringBuffer( );
      buffer.append(“<form id=\“”+formName+“\”>\n”);
      buffer.append(“<nomatch>”);
      buffer.append(“<goto next=\“#”+formName+“\”/>\n”);
      buffer.append(“</nomatch>\n”);
      buffer.append(“<noinput>\n”);
      buffer.append(“<goto next=\“#”+formName+“\”/>\n”);
      buffer.append(“</noinput>\n”)
      buffer.append(“<block>”);
      buffer.append(stripChars(val));
      buffer.append(“</block>”);
      buffer.append(“<field name=\“tmpfield\”>\n”);
      buffer.append(prompt.toString( ));
      buffer.append(grammar.toString( ));
      buffer.append(dtmf.toString( ));
      buffer.append(“<filled>\n”);
      buffer.append(ifcond.toString( ));
      buffer.append(“</filled>\n”);
      buffer.append(“</field>\n”);
      buffer.append(“</form>\n”);
      return buffer.toString( );
    }
/*
```

| | | |
|---|---|---|
| * Function | : | processA |
| * | | |
| * Input | : | link Node |
| * | | |
| * Return | : | None |
| * | | |
| * Purpose | : | converts an <A> i.e. link element into an equivalent for |
| * | | vxml. |

```
*
*/
  private void processA(Node el){
    try {
    StringBuffer linkString = new StringBuffer( );
    StringBuffer link = new StringBuffer( );
    StringBuffer nextStr = new StringBuffer( );
    StringBuffer promptStr = new StringBuffer( );
    String fieldName =“NONAME”+field_id++;
    int dtmfId = 0;
    StringBuffer linkGrammar = new StringBuffer( );
    NamedNodeMap nm = el.getAttributes( );
    int len = (nm != null) ? nm.getLength( ) : 0;
    linkGrammar.append(“<grammar> [(next) (dtmf-1) (dtmf-2) ”);
    for (int j =0; j < len; j++){
      Attr attr = (Attr)nm.item(j);
      if (attr.getNodeName( ).equals(“href”)){
      nextStr.append(“<goto “
+ConvertAtr(el.getNodeName( ),attr.getNodeName( ),
attr.getNodeValue( ))+”/>\n”);
      }
    }
    linkString.append(“<field name=\“”+fieldName+“\”>\n”);
    NodeList nl = el.getChildNodes( );
    len = nl.getLength( );
    link.append(“<filled>\n”);
    for (int j=0; j < len; j++){
      Node el1 = nl.item(j);
      int type = el1.getNodeType( );
      switch (type){
        case Node.TEXT_NODE: {
          if (!el1.getNodeValue( ).trim( ).equals(“”)){
            promptStr.append(“<prompt> Please Say Next or
“+el1.getNodeValue( )+”</prompt>”);
linkGrammar.append(“(“+el1.getNodeValue( ).toLowerCase( )+”)”);
            link.append(“<if cond=\“”+fieldName+“ ==
‘”+el1.getNodeValue( )+“’ || ”+fieldName+“ ==‘dtmf-1’\”>\n”);
            link.append(nextStr);
            link.append(“<else/>\n”);
            link.append(“<prompt>Next Article</prompt>\n”);
            link.append(“</if>\n”);
          }
        }
        break;
      }
    }
    linkGrammar.append(“]</grammar>\n”);
    link.append(“</filled>\n”);
    linkString.append(linkGrammar);
    linkString.append(promptStr);
    linkString.append(link);
    linkString.append(“</field>\n”);
    out.write(“</block>\n”);
    out.write(linkString.toString( ));
    out.write(“<block>\n”);
    }catch (Exception e){
      e.printStackTrace( );
    }
  }
/*
```

| | | |
|---|---|---|
| * Function | : | writeBuffer |
| * | | |
| * Input | : | buffer String |
| * | | |
| * Return | : | None |
| * | | |
| * Purpose | : | print the buffer to PrintWriter. |

```
*
*/
  void writeBuffer(StringBuffer buffer){
  try {
    if (!buffer.toString( ).trim( ).equals(“”)){
      out.write(buffer.toString( ));
      out.write(“\n”);
    }
  }catch (Exception e){
    e.printStackTrace( );
  }
  buffer.delete(0,buffer.length( ));
  }
}
```

The foregoing description, for purposes of explanation, used specific nomenclature to provide a thorough understanding of the invention. However, it will be apparent to one skilled in the art that the specific details are not required in order to practice the invention. In other instances, well-known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the following Claims and their equivalents define the scope of the invention.

What is claimed is:

1. A method for facilitating browsing of the Internet comprising:
receiving a browsing request from a browser unit operative in accordance with a first protocol, said browsing request being issued by said browser unit in response to a first user request for web content;
retrieving web page information from a web site in accordance with said browsing request wherein said web page information includes primary content from a primary page of said web site and secondary content from a secondary page referenced by said primary page, said web page information being formatted in accordance with a second protocol different from said first protocol; and
converting at least said primary content into a primary file of converted information compliant with said first protocol.

2. The method of claim 1 further including:
converting said secondary content into a secondary file of converted information compliant with said first protocol;
receiving an additional browsing request from said browser unit, said additional browsing request being issued by said browser unit in response to a second user request for web content; and
providing said secondary file in response to said additional browsing request.

3. The method of claim 1 wherein said retrieving includes obtaining said web page information using standard Internet protocols.

4. The method of claim 1 wherein said browsing request identifies a conversion script, said conversion script executing upon receipt of said browsing request.

5. The method of claim 1 wherein said first user request identifies a first web site formatted inconsistently with said second protocol, said generating a browsing request including selecting a second web site comprising a version of said first web site formatted consistently with said second protocol.

6. A conversion server responsive to browsing requests issued by a browser unit operative in accordance with a first protocol, said conversion server comprising:
a retrieval module for retrieving web page information from a web site in accordance with a first browsing request issued by said browsing unit wherein said web page information includes primary content from a primary page of said web site and secondary content from a secondary page referenced by said primary page, said web page information being formatted in accordance with a second protocol different from said first protocol;
a conversion module for converting at least said primary content into a primary file of converted information compliant with said first protocol; and
an interface module for providing said primary file of converted information to said browsing unit.

7. The conversion server of claim 6 wherein said conversion module converts said secondary content into a secondary file of converted information compliant with said first protocol, said interface module providing said secondary file of converted information to said browser unit in response to a second browsing request issued by said browser unit.

8. The conversion server of claim 6 wherein said retrieval module performs a branch traversal process in retrieving said web page information, said branch traversal process including includes retrieving tertiary content from at least one tertiary page reference by said secondary page.

9. The conversion server of claim 8 wherein said conversion server further includes a memory cache for storing said secondary content and said tertiary content, said tertiary content being retrieved from said memory cache in response to a third browsing request issued by said browsing unit.

10. The conversion server of claim 6 wherein said conversion module further includes:
a parser for parsing said primary content in accordance with a predefined document type definition and storing a resultant parsed file; and
a mapping module for mapping said parsed file into said primary file of converted information using file conversion rules applicable to said first protocol.

11. A method for facilitating information retrieval from remote information sources comprising:
receiving a browsing request from a browser unit operative in accordance with a first protocol, said browsing request being issued by said browser unit in response to a first user request;
retrieving content from a remote information source in accordance with said browsing request, said content being formatted in accordance with a second protocol different from said first protocol; and
converting, in accordance with a document type definition, said content into a file of converted information compliant with said first protocol.

12. The method of claim 11 wherein said first user request identifies a first web site formatted inconsistently with said second protocol, said generating a browsing request including selecting a second web site as said remote information source wherein said second web site comprises a version of said first web site formatted consistently with said second protocol.

13. The method of claim 12 further including:
receiving at said browsing unit a second user request corresponding to a database formatted inconsistently with said first protocol,
retrieving information from said database, and
converting said information into an additional file of converted information formatted in compliance with said first protocol.

14. A conversion server responsive to browsing requests issued by a browser unit operative in accordance with a first protocol, said conversion server comprising:
a retrieval module for retrieving information from a remote information source in accordance with a first browsing request issued by said browsing unit, said information being formatted in accordance with a second protocol different from said first protocol;
a conversion module for converting said information into a file of converted information compliant with said first protocol, said conversion module including a parser for parsing said information in accordance with a predefined document type definition and storing a resultant parsed file; and
an interface module for providing said file of converted information to said browsing unit.

15. The conversion server of claim 14 wherein said conversion module further includes a mapping module for mapping said parsed file into said file of converted information using file conversion rules applicable to said first protocol.

16. A computer-readable storage medium containing code for controlling a conversion server connected to the Internet, said conversion server interfacing with a browser unit operative in accordance with a first protocol, comprising:
a retrieval routine for controlling retrieval of information from a remote information source in accordance with a first browsing request issued by said browser unit, said information being formatted in accordance with a second protocol different from said first protocol;
a conversion routine for converting at least a primary portion of said information into a file of converted information compliant with said first protocol, said conversion routine including a parser routine for parsing said information in accordance with a predefined document type definition and storing a resultant parsed file; and
an interface routine for providing said primary file of converted information to said browsing unit.

17. The storage medium of claim 16 wherein said remote information source comprises a destination web site, said retrieval routine controlling retrieval of said primary portion of said information from a primary page of said destination web site and secondary content from at least one secondary page of said destination web site linked to said primary page.

18. The storage medium of claim 16 wherein said conversion routine further includes a mapping routine for mapping said parsed file into said file of converted information using file conversion rules applicable to said first protocol.

19. A method for facilitating information retrieval from remote information sources comprising:
receiving a browsing request from a browser unit, said browsing request being issued by said browser unit in response to a first user request;
retrieving content from a remote information source in accordance with said browsing request;
parsing said content in accordance with a predefined document type definition and storing a resultant document object model representation, said document object model representation including a plurality of nodes;
determining a first classification associated with a first of said nodes; and
converting information at said first of said nodes into converted information based upon said first classification.

20. The method of claim 19 further comprising determining a second classification of a second of said nodes and converting information associated with said second of said nodes into converted information based upon said second classification.

21. The method of claim 19 further including
identifying a first child node related to said first of said nodes;
classifying said first child node; and
converting information at said first child node into converted information based upon said classifying.

22. The method of claim 21 further including
identifying a second child node related to said first of said nodes;
classifying said second child node; and
converting information at said second child node into converted information.

23. A method for facilitating information retrieval from remote information sources comprising:
receiving a URL from a browser unit, said URL being issued by said browser unit in response to a first user request;
retrieving content from a remote information source identified by said URL;
parsing said information and storing a resultant document object model representation, said document object model representation including a plurality of nodes organized in a hierarchical structure;
classifying each of said plurality of nodes into one of a set of predefined classifications during traversal of said hierarchical structure, said traversal originating at a root node of said hierarchical structure; and
converting information at each of said plurality of nodes into converted information based upon the one of said predefined classifications associated with each of said nodes.
